(19) United States
(12) Patent Application Publication
(10) Pub. No.: US 2011/0129738 A1
(43) Pub. Date: Jun. 2, 2011

(54) NONAQUEOUS ELECTROLYTE BATTERY

(75) Inventor: Atsumichi Kawashima, Fukushima (JP)

(73) Assignee: SONY CORPORATION, Tokyo (JP)

(21) Appl. No.: 12/953,052

(22) Filed: Nov. 23, 2010

(30) Foreign Application Priority Data
Dec. 2, 2009 (JP) P2009-274436

(51) Int. Cl. H01M 10/02

(52) U.S. Cl. 429/303; 429/188

(57) ABSTRACT

A nonaqueous electrolyte battery includes a positive electrode, a negative electrode and a nonaqueous electrolyte. The nonaqueous electrolyte contains a solvent, an electrolyte salt and an additive. Also, the additive includes an aromatic nitrile compound having two or more nitrogen atoms.

### CROSS REFERENCES TO RELATED APPLICATIONS

The present application claims priority to Japanese Patent Application JP 2009-274436 filed on Dec. 2, 2009, the entire contents of which is hereby incorporated by reference.

### BACKGROUND

The present disclosure relates to a nonaqueous electrolyte battery. In particular, the present disclosure relates to a nonaqueous electrolyte battery using a nonaqueous electrolyte containing an organic solvent, an electrolyte salt and an additive.

In recent years, a number of portable electronic appliances such as a camera-integrated VTR, a digital still camera, a mobile phone, a personal digital assistant and a laptop computer have appeared, and it is contrived to achieve downsizing and weight reduction thereof. With respect to batteries, in particular, secondary batteries as a portable power source for such an electronic appliance, research and development have been actively conducted for the purpose of enhancing the energy density.

Above all, lithium ion secondary batteries using carbon for a negative electrode active material, a lithium-transition metal complex oxide for a positive electrode active material and a carbonate mixture for an electrolytic solution are widely put into practical use because a large energy density is obtained as compared with lead batteries and nickel-cadmium batteries which are a nonaqueous electrolytic solution secondary battery of the related art.

In the lithium ion secondary batteries, since a charge voltage is high as 4.2 V, there is involved such a problem that the solvent is decomposed at the time of initial charge, thereby causing a lowering of the charge and discharge efficiency. Besides, in the lithium ion secondary batteries, there is involved such a problem that the battery causes blister by a gas generated due to the decomposition of an electrolytic solution in the inside of the battery at high temperatures.

In response to the issue of battery blister, for example, JP-A-2005-72003 proposes the use of an electrolytic solution containing an aliphatic nitrile compound having one nitrogen atom, such as acetonitrile, an aromatic nitrile compound having one nitrogen atom, such as 2-fluorobenzonitrile, or the like.

### SUMMARY

However, even by using an electrolytic solution containing an aliphatic nitrile compound having one nitrogen atom or an aromatic nitrile compound having one nitrogen atom, it may be impossible to sufficiently suppress a lowering of the initial charge and discharge efficiency to be caused due to the decomposition of a solvent at the time of initial charge.

Thus, it is desirable to provide a nonaqueous electrolyte battery capable of enhancing the initial charge and discharge efficiency.

According to an embodiment, there is provided a nonaqueous electrolyte battery including a positive electrode, a negative electrode and a nonaqueous electrolyte, wherein the nonaqueous electrolyte contains a solvent, an electrolyte salt and an additive; and the additive includes an aromatic nitrile compound having two or more nitrogen atoms.

In this embodiment, the nonaqueous electrolyte contains, as the additive, an aromatic nitrile compound having two or more nitrogen atoms. The aromatic nitrile compound having two or more nitrogen atoms is decomposed on the negative electrode surface to form a protective film, thereby suppressing the decomposition of a prime solvent. According to this, the initial charge and discharge efficiency can be enhanced.

Additional features and advantages are described herein, and will be apparent from the following Detailed Description and the figures.

### BRIEF DESCRIPTION OF THE FIGURES

FIG. 1 is an exploded perspective view showing a configuration example of a nonaqueous electrolyte battery according to a first embodiment.

FIG. 2 is a sectional view along an I-I line of a wound electrode body in FIG. 1.

FIG. 3 is a sectional view showing a configuration example of a nonaqueous electrolyte battery according to a third embodiment.

FIG. 4 is a sectional view enlargedly showing a part of a wound electrode body in FIG. 3.

### DETAILED DESCRIPTION

Embodiments are hereunder described with reference to the drawings. The description is made in the following order.

1. First embodiment (first example of a nonaqueous electrolyte battery)

2. Second embodiment (second example of a nonaqueous electrolyte battery)

3. Third embodiment (third example of a nonaqueous electrolyte battery)

4. Other embodiments (modifications)

### 1. First Embodiment

### Configuration of Battery

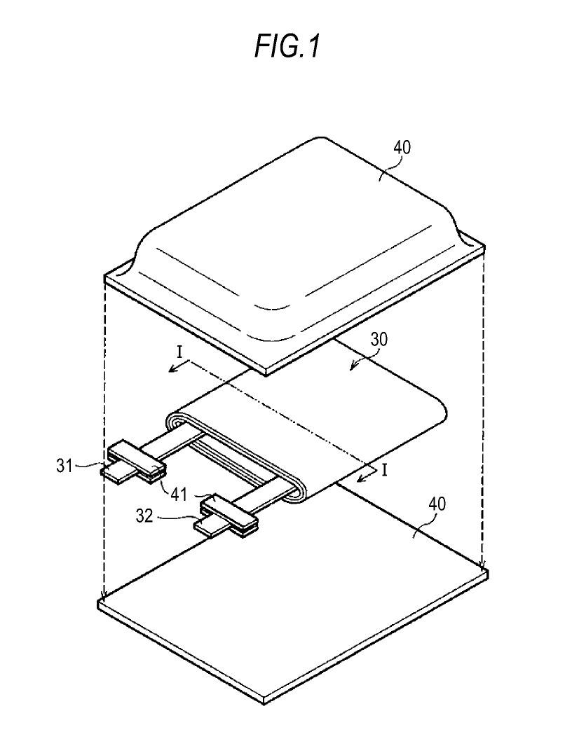

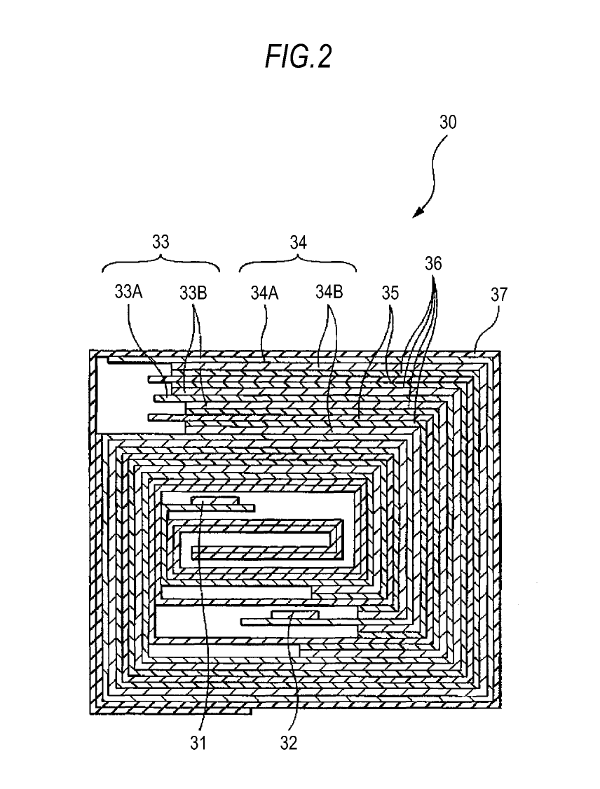

A nonaqueous electrolyte battery according to a first embodiment is described below. FIG. 1 expresses an exploded perspective configuration of a nonaqueous electrolyte battery according to the first embodiment; and FIG. 2 enlargedly shows a section along an I-I line of a wound electrode body 30 shown in FIG. 1.

This nonaqueous electrolyte battery is chiefly one in which a wound electrode body 30 having a positive electrode lead 31 and a negative electrode lead 32 installed therein is housed in the inside of an exterior member 40 in a film form. The battery structure using this exterior member 40 in a film form is called a laminated film type.

The positive electrode lead 31 and the negative electrode lead 32 are each led out in, for example, the same direction from the inside toward the outside of the exterior member 40. The positive electrode lead 31 is constituted of a metal material, for example, aluminum, etc., and the negative electrode lead 32 is constituted of a metal material, for example, copper, nickel, stainless steel, etc. Such a metal material is, for example, formed in a thin plate state or a network state.

The exterior member 40 is constituted of, for example, an aluminum laminated film obtained by sticking a nylon film, an aluminum foil and a polyethylene film in this order. For example, this exterior member 40 has a structure in which respective outer edges of the two rectangular aluminum laminated films are allowed to adhere to each other by means of fusion or with an adhesive such that the polyethylene film is disposed opposing to the wound electrode body 30.

A contact film 41 is inserted between the exterior member 40 and each of the positive electrode lead 31 and the negative electrode lead 32 for the purpose of preventing invasion of the outside air. This contact film 41 is constituted of a material having adhesion to each of the positive electrode lead 31 and the negative electrode lead 32. Examples of such a material include polyolefin resins such as polyethylene, polypropylene, modified polyethylene and modified polypropylene.

The exterior member 40 may be constituted of a laminated film having other structure, or constituted of a polymer film such as polypropylene or a metal film, in place of the foregoing aluminum laminated film.

FIG. 2 shows a sectional configuration along an I-I line of the wound electrode body 30 shown in FIG. 1. This wound electrode body 30 is one prepared by laminating a positive electrode 33 and a negative electrode 34 via a separator 35 and an electrolyte 36 and winding the laminate, and an outermost peripheral part thereof is protected by a protective tape 37.

(Positive Electrode)

The positive electrode 33 is one in which a positive electrode active material layer 33B is provided on the both surfaces of a positive electrode collector 33A having a pair of surfaces opposing to each other. However, the positive electrode active material layer 33B may be provided on only one surface of the positive electrode collector 33A.

The positive electrode collector 33A is constituted of a metal material, for example, aluminum, nickel, stainless steel, etc.

The positive electrode active material layer 33B contains, as a positive electrode active material, one kind or two or more kinds of a positive electrode material capable of intercalating and deintercalating lithium and may further contain other materials such as a binder and a conductive agent, if desired.

As the positive electrode material capable of intercalating and deintercalating lithium, for example, lithium complex oxides such as lithium cobaltate, lithium nickelate and solid solutions thereof {for example, Li(NiₓCo_{y}Mn_{z})O₂ (values of x, y and z are satisfied with relations of (0<x<1), (0<y<1), (0≦z<1) and (x+y+z)=1, respectively), Li(NiₓCo_{y}Al_{z})O₂ (values of x, y and z are satisfied with relations of (0<x<1), (0<y<1), (0≦z<1) and (x+y+z)=1, respectively), etc.}; manganese spinel (LiMn₂O₄) and solid solutions thereof {for example, Li(Mn₂₋ᵥNiᵥ)O₄ (a value of v is satisfied with a relation of (v<2)), etc.}; and phosphate compounds having an olivine structure, such as lithium iron phosphate (LiFePO₄), are preferable. This is because a high energy density can be obtained. Also, examples of the positive electrode material capable of intercalating and deintercalating lithium include oxides such as titanium oxide, vanadium oxide and manganese dioxide; disulfides such as iron disulfide, titanium disulfide and molybdenum sulfide; sulfur; and conductive polymers such as polyaniline and polythiophene.

As a matter of course, the positive electrode material capable of intercalating and deintercalating lithium may be other material than those exemplified above.

Examples of the binder include synthetic rubbers such as a styrene butadiene based rubber, a fluorocarbon based rubber and an ethylene propylene diene based rubber; and polymer materials such as polyvinylidene fluoride. These materials may be used singly or in admixture of plural kinds thereof.

Examples of the conductive agent include carbon materials such as graphite and carbon black. These materials are used singly or in admixture of plural kinds thereof.

(Negative Electrode)

The negative electrode 34 is one in which a negative electrode active material layer 34B is provided on the both surfaces of a negative electrode collector 34A having a pair of surfaces opposing to each other. However, the negative electrode active material layer 34B may be provided on only one surface of the negative electrode collector 34A.

The negative electrode collector 34A is constituted of a metal material, for example, copper, nickel, stainless steel, etc.

The negative electrode active material layer 34B contains, as a negative electrode active material, one kind or two or more kinds of a negative electrode material capable of intercalating and deintercalating lithium and may contain other materials such as a binder and a conductive agent, if desired. As the binder and the conductive agent, the same materials as those explained above with respect to the positive electrode can be used.

Examples of the negative electrode material capable of intercalating and deintercalating lithium include carbon materials. Examples of such a carbon material include easily graphitized carbon, hardly graphitized carbon with a (002) plane interval of 0.37 nm or more and graphite with a (002) plane interval of not more than 0.34 nm. More specifically, there are exemplified pyrolytic carbons, cokes, vitreous carbon fibers, organic polymer compound baked materials, active carbon and carbon blacks. Of these, examples of the cokes include pitch coke, needle coke and petroleum coke. The organic polymer compound baked material as referred to herein is a material obtained through carbonization by baking a phenol resin, a furan resin or the like at an appropriate temperature. The carbon material is preferable because a change in a crystal structure following the intercalation and deintercalation of lithium is very small, and therefore, a high energy density is obtained, an excellent cycle characteristic is obtained, and the carbon material also functions as a conductive agent. The shape of the carbon material may be any of a fibrous shape, a spherical shape, a granular shape or a flaky shape.

In addition to the foregoing carbon materials, examples of the negative electrode material capable of intercalating and deintercalating lithium include a material capable of intercalating and deintercalating lithium and containing, as a constituent element, at least one member selected from the group consisting of metal elements and semi-metal elements. This is because a high energy density is obtained. Such a negative electrode material may be a simple substance, an alloy or a compound of a metal element or a semi-metal element. Also, one having one kind or two or more kinds of a phase in at least a part thereof may be used. The “alloy” as referred to herein includes, in addition to alloys composed of two or more kinds of a metal element, alloys containing one or more kinds of a metal element and one or more kinds of a semi-metal element. Also, the “alloy” may contain a non-metal element. Examples of its texture include a solid solution, a eutectic (eutectic mixture), an intermetallic compound and one in which two or more kinds thereof coexist.

Examples of the metal element or semi-metal element include a metal element or a semi-metal element capable of forming an alloy together with lithium. Specific examples thereof include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd) and platinum (Pt). Of these, at least one member selected from silicon and tin is preferable, and silicon is more preferable. This is because silicon and tin have large capability to intercalate and deintercalate lithium, so that a high energy density is obtained.

Examples of the negative electrode material containing at least one member selected from silicon and tin include a simple substance, an alloy or a compound of silicon; a simple substance, an alloy or a compound of tin; and one having one kind or two or more kinds of a phase in at least a part thereof.

Examples of alloys of silicon include alloys containing, as a second constituent element other than silicon, at least one member selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr). Examples of alloys of tin include alloys containing, as a second constituent element other than tin (Sn), at least one member selected from the group consisting of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr).

Examples of compounds of silicon or compounds of tin include compounds containing oxygen (O) or carbon (C), and these compounds may further contain the foregoing second constituent element in addition to silicon (Si) or tin (Sn).

As the negative electrode material containing at least one member selected from silicon (Si) and tin (Sn), for example, a material containing tin (Sn) as a first constituent element and in addition to this tin (Sn), a second constituent element and a third constituent element is especially preferable. As a matter of course, this negative electrode material may be used together with the foregoing negative electrode material. The second constituent element is at least one member selected from the group consisting of cobalt (Co), iron (Fe), magnesium (Mg), titanium (Ti), vanadium (V), chromium (Cr), manganese (Mn), nickel (Ni), copper (Cu), zinc (Zn), gallium (Ga), zirconium (Zr), niobium (Nb), molybdenum (Mo), silver (Ag), indium (In), cerium (Ce), hafnium (Hf), tantalum (Ta), tungsten (W), bismuth (Bi) and silicon (Si). The third constituent element is at least one member selected from the group consisting of boron (B), carbon (C), aluminum (Al) and phosphorus (P). This is because when the second constituent element and the third constituent element are contained, a cycle characteristic is enhanced.

Above of all, the negative electrode material is preferably an SnCoC-containing material containing tin (Sn), cobalt (Co) and carbon (C) as constituent elements and having a content of carbon (C) in the range of 9.9% by mass or more and not more than 29.7% by mass and a proportion of cobalt (Co) to the total sum of tin (Sn) and cobalt (Co) (Co/(Sn+Co)) in the range of 30% by mass or more and not more than 70% by mass. This is because in the foregoing composition range, not only a high energy density is obtained, but an excellent cycle characteristic is obtained.

This SnCoC-containing material may further contain other constituent elements, if desired. As other constituent elements, for example, silicon (Si), iron (Fe), nickel (Ni), chromium (Cr), indium (In), niobium (Nb), germanium (Ge), titanium (Ti), molybdenum (Mo), aluminum (Al), phosphorus (P), gallium (Ga) and bismuth (Bi) are preferable. The SnCoC-containing material may contain two or more kinds of these elements. This is because a capacity characteristic or a cycle characteristic is more enhanced.

The SnCoC-containing material has a phase containing tin (Sn), cobalt (Co) and carbon (C), and this phase is preferably a lowly crystalline or amorphous phase. Also, in the SnCoC-containing material, it is preferable that at least a part of carbon as the constituent element is bounded to a metal element or a semi-metal element as other constituent element. This is because though it may be considered that a lowering of the cycle characteristic is caused due to aggregation or crystallization of tin (Sn) or the like, when carbon is bound to other element, such aggregation or crystallization is suppressed.

Examples of a measurement method for examining the binding state of elements include X-ray photoelectron spectroscopy (XPS). In this XPS, so far as graphite is concerned, a peak of the 1s orbit (C1s) of carbon appears at 284.5 eV in an energy-calibrated apparatus such that a peak of the 4f orbit of a gold atom (Au4f) is obtained at 84.0 eV. Also, so far as surface contamination carbon is concerned, a peak of the 1s orbit (C1s) of carbon appears at 284.8 eV. On the contrary, in the case where a charge density of the carbon element is high, for example, in the case where carbon is bound to a metal element or a semi-metal element, the peak of C1s appears in a lower region than 284.5 eV. That is, in the case where a peak of a combined wave of C1s obtained regarding the SnCoC-containing material appears in a lower region than 284.5 eV, at least a part of carbon (C) contained in the SnCoC-containing material is bound to a metal element or a semi-metal element as other constituent element.

In the XPS measurement, for example, the peak of C1s is used for correcting the energy axis of a spectrum. In general, since surface contamination carbon exists on the surface, the peak of C1s of the surface contamination carbon is fixed at 284.8 eV, and this peak is used as an energy reference. In the XPS measurement, since a waveform of the peak of C1s is obtained as a form including the peak of the surface contamination carbon and the peak of carbon in the SnCoC-containing material, the peak of the surface contamination carbon and the peak of the carbon in the SnCoC-containing material are separated from each other by means of analysis using, for example, a commercially available software. In the analysis of the waveform, the position of a main peak existing on the side of a lowest binding energy is used as an energy reference (284.8 eV).

Also, examples of the negative electrode material capable of intercalating and deintercalating lithium include metal oxides and polymer compounds, each of which is capable of intercalating and deintercalating lithium. Examples of the metal oxide include iron oxide, ruthenium oxide and molybdenum oxide; and examples of the polymer compound include polyacetylene, polyaniline and polypyrrole.

Furthermore, the negative electrode material capable of intercalating and deintercalating lithium may be a material containing an element capable of forming a complex oxide with lithium, such as titanium.

As a matter of course, metallic lithium may be used as the negative electrode active material, thereby depositing and dissolving the metallic lithium. It is also possible to deposit and dissolve magnesium or aluminum other than lithium.

The negative electrode active material layer 34B may be, for example, formed by any of a vapor phase method, a liquid phase method, a spraying method, a baking method or a coating method, or a combined method of two or more kinds of these methods. Examples of the vapor phase method include a physical deposition method and a chemical deposition method, specifically a vacuum vapor deposition method, a sputtering method, an ion plating method, a laser abrasion method, a thermal chemical vapor deposition (CVD) method and a plasma chemical vapor deposition method. As the liquid phase method, known techniques such as electrolytic plating and non-electrolytic plating can be adopted. The baking method as referred to herein is, for example, a method in which after a granular negative electrode active material is mixed with a binder and the like, the mixture is dispersed in a solvent and coated, and the coated material is then heat treated at a higher temperature than a melting point of the binder, etc. As to the baking method, known techniques can be utilized, too, and examples thereof include an atmospheric baking method, a reaction baking method and a hot press baking method.

In the case of using metallic lithium as the negative electrode active material, the negative electrode active material layer 34B may be previously provided at the time of assembling. However, it may be absent at the time of assembling but may be constituted of a lithium metal deposited at the time of charge. Also, the negative electrode collector 34A may be omitted by utilizing the negative electrode active material layer 34B as a collector.

(Separator)

The separator 35 partitions the positive electrode 33 and the negative electrode 34 from each other and allows a lithium ion to pass therethrough while preventing a short circuit of the current to be caused due to the contact between the both electrodes. This separator 35 is constituted of, for example, a porous film made of a synthetic resin such as polytetrafluoroethylene, polypropylene and polyethylene; a porous film made of a ceramic; or the like, and a laminate of two or more kinds of these porous films may also be used.

(Electrolyte)

The electrolyte 36 contains an electrolytic solution and a polymer compound having swollen upon absorbing the electrolytic solution and is an electrolyte in a so-called gel form. In this electrolyte in a gel form, the electrolytic solution is held on the polymer compound. The electrolyte in a gel form is preferable because not only a high ionic conductivity is obtained, but the liquid leakage can be prevented from occurring.

(Electrolytic Solution)

The electrolytic solution contains a solvent, an electrolyte salt and an additive.

(Solvent)

As the solvent, for example, a high-dielectric constant solvent can be used. As the high-dielectric constant solvent, a cyclic carbonate such as ethylene carbonate, propylene carbonate and butylene carbonate, and so forth can be used. As the high-dielectric constant solvent, a lactone such as γ-butyrolactone and γ-valerolactone; a lactam such as N-methylpyrrolidone; a cyclic carbamate such as N-methyloxazolidinone; or a sulfone compound such as tetramethylene sulfone may be used in place of the cyclic carbonate or together with the cyclic carbonate.

As the solvent, a mixture of the high-dielectric constant solvent with a low-viscosity solvent may also be used. Examples of the low-viscosity solvent include chain carbonates such as ethyl methyl carbonate, diethyl carbonate, dimethyl carbonate and methyl propyl carbonate; chain carboxylates such as methyl acetate, ethyl acetate, methyl propionate, ethyl propionate, methyl butyrate, methyl isobutyrate, methyl trimethylacetate and ethyl trimethylacetate; chain amides such as N,N-dimethylacetamide; chain carbamates such as methyl N,N-diethylcarbamate and ethyl N,N-diethylcarbamate; and ethers such as 1,2-dimethoxyethane, tetrahydrofuran, tetrahydropyrane and 1,3-dioxolane. It should not be construed that the solvent is limited to the above-exemplified compounds, and compounds which have hitherto been proposed can be widely used.

(Electrolyte Salt)

The electrolyte salt contains, for example, one kind or two or more kinds of a light metal salt such as a lithium salt.

Examples of the lithium salt include inorganic lithium salts such as lithium hexafluorophosphate (LiPF6), lithium tetrafluoroborate (LiBF₄), lithium hexafluoroarsenate (LiAsF₆), lithium hexafluoroantimonate (LiSbF₆), lithium perchlorate (LiClO₄) and lithium tetrachloroaluminate (LiAlCl₄). Also, examples of the lithium salt include lithium salts of perfluoroalkanesulfonic acid derivatives such as lithium trifluoromethanesulfonate (CF₃SO₃Li), lithium bis(trifluoromethanesulfone)imide ((CF₃SO₂)₂NLi), lithium bis(pentafluoroethanesulfone)imide ((C₂F₅SO₂)₂NLi) and lithium tris(trifluoromethanesulfone)methide ((CF₃SO₂)₃CLi).

(Additive)

The electrolytic solution contains an aromatic nitrile compound having two or more nitrogen atoms as the additive. When the aromatic nitrile compound having two or more nitrogen atoms is contained in the electrolytic solution, the initial charge and discharge efficiency can be enhanced. For example, in the case of using an aromatic nitrile compound having one nitrogen atom, such as benzonitrile, it may be substantially impossible to enhance the initial charge and discharge efficiency. It may be considered that in view of the fact that two or more nitrogen atom are present in the molecule, the reactivity of the aromatic nitrile compound increases, so that the aromatic nitrile compound is decomposed on the surface of the electrode (negative electrode) to form a protective film, thereby suppressing the decomposition of a prime solvent. It may be considered that when the nitrogen atom number in the molecule of the aromatic nitrile compound is excessively large, it becomes excessively unstable, so that the effect as the protective film becomes weak. Thus, the nitrogen atom number in the molecule is preferably not more than 4.

Examples of the aromatic nitrile compound having two or more nitrogen atoms include aromatic nitrile compounds having a structure in which two or more cyano groups are bound on a benzene ring. Examples of this aromatic nitrile compound having a structure in which two or more cyano groups are bound on a benzene ring include an aromatic nitrile compound represented by the following formula (1). More specifically, examples thereof include aromatic nitrile compounds represented by the following formulae (2) to (3).

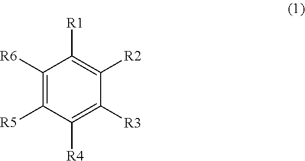

In the formula (1), each of R1 to R6 independently represents a CₘH₂ₘ₊₁ group (0≦m≦4), an F group, a Cl group, a Br group or a CN group; and at least two of R1 to R6 are a CN group.

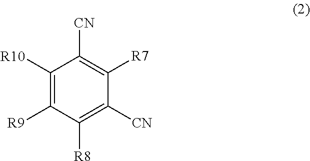

In the formula (2), each of R7 to R10 independently represents a CₘH₂ₘ₊₁ group (0≦m≦4), an F group, a Cl group, a Br group or a CN group.

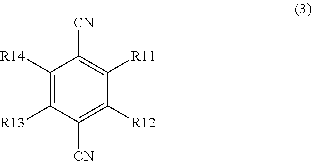

In the formula (3), each of R11 to R14 independently represents a CₘH₂ₘ₊₁ group (0≦m≦4), an F group, a Cl group, a Br group or a CN group.

Also, as the aromatic nitrile compound having two or more nitrogen atoms, an aromatic nitrile compound having a structure in which one or more cyano groups are bound on a pyridine ring, which is represented by the following formula (4), is exemplified. An aromatic nitrile compound having a structure in which one or more cyano groups are bound on a pyrazine ring, which is represented by the following formula (5), is exemplified. An aromatic nitrile compound having a structure in which one or more cyano groups are bound on a pyrimidine ring, which is represented by the following formula (6), is exemplified.

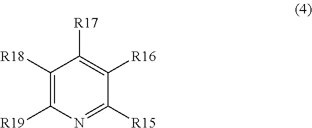

In the formula (4), each of R15 to R19 independently represents a CₘH₂ₘ₊₁ group (0≦m≦4), an F group, a Cl group, a Br group or a CN group; and at least one of R15 to R19 is a CN group.

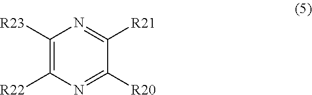

In the formula (5), each of R20 to R23 independently represents a CₘH₂ₘ₊₁ group (0≦m≦4), an F group, a Cl group, a Br group or a CN group; and at least one of R20 to R23 is a CN group.

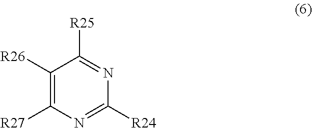

In the formula (6), each of R24 to R27 independently represents a CₘH₂ₘ₊₁ group (0≦m≦4), an F group, a Cl group, a Br group or a CN group; and at least one of R24 to R27 is a CN group.

More specifically, examples of the aromatic nitrile compound represented by the formula (1) include dicaynobenzenes such as phthalonitrile represented by the following formula (7), isophthalonitrile represented by the following formula (8) and terephthalonitrile represented by the following formula (9); and 1,2,3,5-tetracyanobenzene represented by the following formula (10).

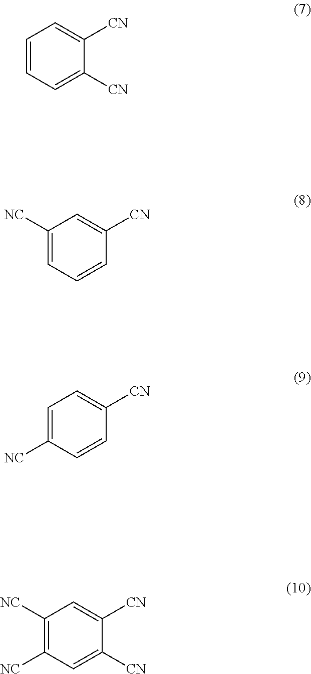

Of the dicyanobenzenes, an m-dicyanobenzene such as isophthalonitrile and a p-dicyanobenzene such as terephthalonitrile are more preferable than an o-dicyanobenzene such as phthalonitrile. In the o-dicyanobenzene, since the cyano groups are adjacent to each other, the capability to chelate-coordinate with a metal ion is large, so that the compound tends to be adsorbed on the positive electrode which is a metal oxide. For that reason, it may be considered that the o-dicyanobenzene is poor in the capability to form a sufficient protective film on the negative electrode, and therefore, the m-dicyanobenzene and the p-dicyanobenzene are more preferable from the standpoint of enhancing the initial charge and discharge efficiency.

More specifically, examples of the aromatic nitrile compound represented by the formula (4) include 2-cyanopyridine represented by the following formula (11), 3-cyanopyridine represented by the following formula (12) and 4-cyanopyridine represented by the following formula (13). More specifically, examples of the aromatic nitrile compound represented by the formula (5) include cyanopyrazine represented by the following formula (14) and 2,3-dicyanopyrazine represented by the following formula (15). More specifically, examples of the aromatic nitrile compound represented by the formula (6) include 2-cyanopyrimidine represented by the following formula (16).

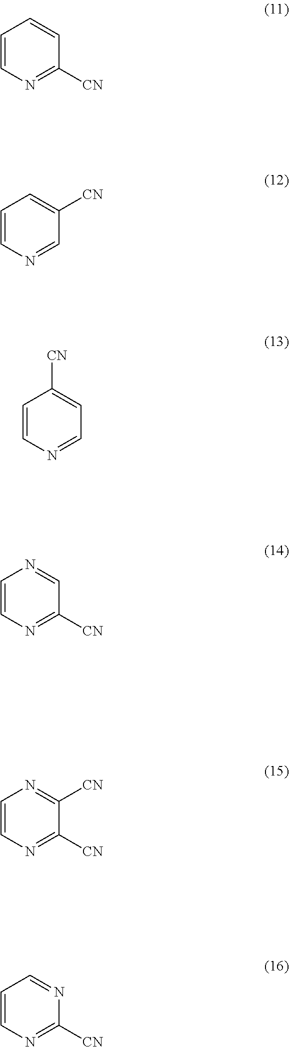

A content of the aromatic nitrile compound having two or more nitrogen atoms is, for example, 0.05% by mass or more and not more than 0.5% by mass relative to the whole mass of the electrolytic solution. From the standpoint of obtaining more effects, the content of the aromatic nitrile compound having two or more nitrogen atoms is preferably 0.1% by mass or more and not more than 0.3% by mass.

It is more effective to use the aromatic nitrile compound having two or more nitrogen atoms together with a carbonate having a carbon-carbon multiple bond such as vinylene carbonate and vinyl ethylene carbonate, or a halogenated carbonate such as 4-fluoro-1,3-dioxolan-2-one (fluoroethylene carbonate), 4-chloro-1,3-dioxolan-2-one (chloroethylene carbonate) and trifluoropropylene carbonate. This is because such a carbonate improves the initial charge and discharge efficiency by forming a protective film through another mechanism, so that a synergistic effect is obtained.

(Polymer Compound)

As the polymer compound, one which absorbs the solvent to cause gelation can be used. The polymer compound may be used singly or in admixture of two or more kinds thereof, or may be a copolymer of two or more kinds thereof. Specifically, polyvinyl formal represented by the following formula (17), a polyacrylate represented by the following formula (18), polyvinylidene fluoride represented by the following formula (19), a copolymer of vinylidene fluoride and hexafluoropropylene and the like can be used.

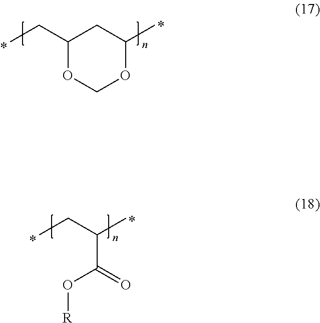

In the formula (18), R represents a CₐH₂ₐ₋₁Oₘ group; a is satisfied with a relation of (1≦a≦8); and m is satisfied with a relation of (0≦m≦4).

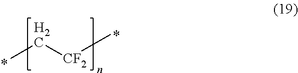

(Manufacturing Method of Battery)

This nonaqueous electrolyte battery is, for example, manufactured by the following three kinds of manufacturing methods (first to third manufacturing methods).

(First Manufacturing Method)

(Manufacture of Positive Electrode)

First of all, the positive electrode 33 is fabricated. For example, a positive electrode material, a binder and a conductive agent are mixed to form a positive electrode mixture, which is then dispersed in an organic solvent to form a positive electrode mixture slurry in a paste form. Subsequently, the positive electrode mixture slurry is uniformly coated on the both surfaces of the positive electrode collector 33A by a doctor blade or a bar coater or the like and then dried. Finally, the coating film is subjected to compression molding by a roll press or the like while heating, if desired, thereby forming the positive electrode active material layer 33B. In that case, the compression molding may be repeatedly carried out plural times.

(Manufacture of Negative Electrode)

Next, the negative electrode 34 is fabricated. For example, a negative electrode material and a binder and optionally, a conductive agent are mixed to form a negative electrode mixture, which is then dispersed in an organic solvent to form a negative electrode mixture slurry in a paste form. Subsequently, the negative electrode mixture slurry is uniformly coated on the both surfaces of the negative electrode collector 34A by a doctor blade or a bar coater or the like and then dried. Finally, the coating film is subjected to compression molding by a roll press or the like while heating, if desired, thereby forming the negative electrode active material layer 34B.

Subsequently, a precursor solution containing an electrolytic solution, a polymer compound and a solvent is prepared and coated on each of the positive electrode 33 and the negative electrode 34, and the solvent is then vaporized to form the electrolyte 36 in a gel form. Subsequently, the positive electrode lead 31 is installed in the positive electrode collector 33A, and the negative electrode lead 32 is also installed in the negative electrode collector 34A.

Subsequently, the positive electrode 33 and the negative electrode 34 each having the electrolyte 36 formed thereon are laminated via the separator 35, the laminate is then wound in a longitudinal direction thereof, and the protective tape 37 is allowed to adhere to an outermost peripheral part thereof, thereby fabricating the wound electrode body 30. Finally, for example, the wound electrode body 30 is interposed between the two exterior members 40 in a film form, and the outer edges of the exterior members 40 are allowed to adhere to each other by means of heat fusion, etc., thereby sealing the wound electrode body 30 therein. On that occasion, the contact film 41 is inserted between each of the positive electrode lead 31 and the negative electrode lead 32 and the exterior member 40. There is thus completed the nonaqueous electrolyte battery shown in FIGS. 1 and 2.

(Second Manufacturing Method)

First of all, each of the positive electrode 33 and the negative electrode 34 is fabricated in the same manner as in the first manufacturing method. Next, the positive electrode lead 31 is installed in the positive electrode 33, and the negative electrode lead 32 is also installed in the negative electrode 34. Subsequently, the positive electrode 33 and the negative electrode 34 are laminated via the separator 35 and wound, and the protective tape 37 is then allowed to adhere to an outermost peripheral part of the resulting laminate, thereby fabricating a wound body serving as a precursor of the wound electrode body 30.

Subsequently, the wound body is interposed between the two exterior members 40 in a film form, and the outer edges exclusive of one side are allowed to adhere to each other by means of heat fusion, etc., thereby housing the wound body in the inside of the exterior member 40 in a bag form. Subsequently, an electrolyte composition containing an electrolytic solution and a monomer as a raw material of the polymer compound and a polymerization initiator and optionally, other material such as a polymerization inhibitor is prepared and injected into the inside of the exterior member 40 in a bag form. Thereafter, an opening of the exterior member 40 is hermetically sealed by means of heat fusion, etc. Finally, the monomer is heat polymerized to form a polymer compound, thereby forming the electrolyte layer 36 in a gel form. There is thus completed the nonaqueous electrolyte battery shown in FIGS. 1 and 2.

(Third Manufacturing Method)

In the third manufacturing method, a wound body is formed and then housed in the inside of the exterior member 40 in a bag form in the same manner as in the foregoing second manufacturing method, except that the separator 35 having a polymer compound coated on the both surfaces thereof is first used.

Examples of the polymer compound which is coated on this separator 35 include polymers composed of, as a component, vinylidene fluoride, namely a homopolymer, a copolymer or a multi-component copolymer, or the like. Specific examples thereof include polyvinylidene fluoride; a binary copolymer composed of, as components, vinylidene fluoride and hexafluoropropylene; and a ternary copolymer composed of, as components, vinylidene fluoride, hexafluoropropylene and chlorotrifluoro ethylene.

The polymer compound may contain one kind or two or more kinds of other polymer compounds together with the foregoing polymer composed of, as a component, vinylidene fluoride. Subsequently, an electrolytic solution is prepared and injected into the inside of the exterior member 40, and an opening of the exterior member 40 is then hermetically sealed by means of heat fusion, etc. Finally, the separator 35 is brought into intimate contact with each of the positive electrode 33 and the negative electrode 34 via the polymer compound upon heating while adding a weight to the exterior member 40. According to this, the electrolytic solution is impregnated into the polymer compound, and the polymer compound is gelled to form the electrolyte 36. There is thus completed the nonaqueous electrolyte battery shown in FIGS. 1 and 2.

This nonaqueous electrolyte battery is, for example, a nonaqueous electrolyte secondary battery capable of undergoing charge and discharge. For example, when charged, a lithium ion is deintercalated from the positive electrode 33 and intercalated in the negative electrode 34 via the electrolyte 36. When discharged, the lithium ion is deintercalated from the negative electrode 34 and intercalated in the positive electrode 33 via the electrolyte 36. Also, for example, when charged, the lithium ion in the electrolyte 36 receives an electron and is deposited as metallic lithium on the negative electrode 34. When discharged, the metallic lithium of the negative electrode 34 deintercalates an electron and is dissolved as a lithium ion in the electrolyte 36. Also, for example, when charged, the lithium ion is deintercalated from the positive electrode 33 and intercalated in the electrode 34 via the electrolyte 36, and the metallic lithium is deposited on the way of charge. When discharged, the deposited metallic lithium deintercalates an electron in the negative electrode 34 and is dissolved as a lithium ion in the electrolyte 36; the lithium ion intercalated in the negative electrode 34 is deintercalated on the way of discharge; and these lithium ions are intercalated in the positive electrode 33 via the electrolyte 36.

<Effect>

In the nonaqueous electrolyte battery of a laminated film type according to the first embodiment, the nonaqueous electrolyte contains, as the additive, an aromatic nitrile compound having two or more nitrogen atoms. The aromatic nitrile compound having two or more nitrogen atoms is decomposed on the surface of the negative electrode to form a protective film, thereby suppressing the decomposition of a prime solvent. According to this, the initial charge and discharge efficiency can be enhanced.

### 2. Second Embodiment

A nonaqueous electrolyte battery according to a second embodiment is described. The nonaqueous electrolyte battery according to the second embodiment of the present invention is the same as the nonaqueous electrolyte battery according to the first embodiment, except that the electrolytic solution is used as it is, in place of the electrolyte solution held on a polymer compound (the electrolyte 36). In consequence, its configuration is hereunder described in detail centering on points different from those in the first embodiment.

(Configuration of Battery)

In the nonaqueous electrolyte battery according to the second embodiment, an electrolytic solution is used in place of the electrolyte 36 in a gel form. In consequence, the wound electrode body 30 has a configuration in which the electrolyte 36 is omitted, and the electrolytic solution is impregnated in the separator 35.

(Manufacturing Method of Battery)

This nonaqueous electrolyte battery is, for example, manufactured by the following method.

First all, for example, a positive electrode active material, a binder and a conductive agent are mixed to prepare a positive electrode mixture, which is then dispersed in a solvent such as N-methyl-2-pyrrolidone to prepare a positive electrode mixture slurry. Next, this positive electrode mixture slurry is coated on the both surfaces of the positive electrode collector 33A, dried and then subjected to compression molding to form the positive electrode active material layer 33B, thereby fabricating the positive electrode 33. Next, for example, the positive electrode lead 31 is connected with the positive electrode collector 33A by means of, for example, ultrasonic welding, spot welding, etc.

Also, for example, a negative electrode material and a binder are mixed to prepare a negative electrode mixture, which is then dispersed in a solvent such as N-methyl-2-pyrrolidone to prepare a negative electrode mixture slurry. Next, this negative electrode mixture slurry is coated on the both surfaces of the negative electrode collector 34A, dried and then subjected to compression molding to form the negative electrode active material layer 34B, thereby fabricating the negative electrode 34. Next, for example, the negative electrode lead 32 is connected with the negative electrode collector 34A by means of, for example, ultrasonic welding, spot welding, etc.

Subsequently, the positive electrode 33 and the negative electrode 34 are wound via the separator 35 and interposed in the inside of the exterior member 40, and an electrolytic solution is then injected into the inside of the exterior member 40, followed by hermetically sealing the exterior member 40. According to this, the nonaqueous electrolyte battery shown in FIGS. 1 and 2 is obtained.

<Effect>

The second embodiment has the same effect as that in the first embodiment.

### 3. Third Embodiment

### Configuration of Battery

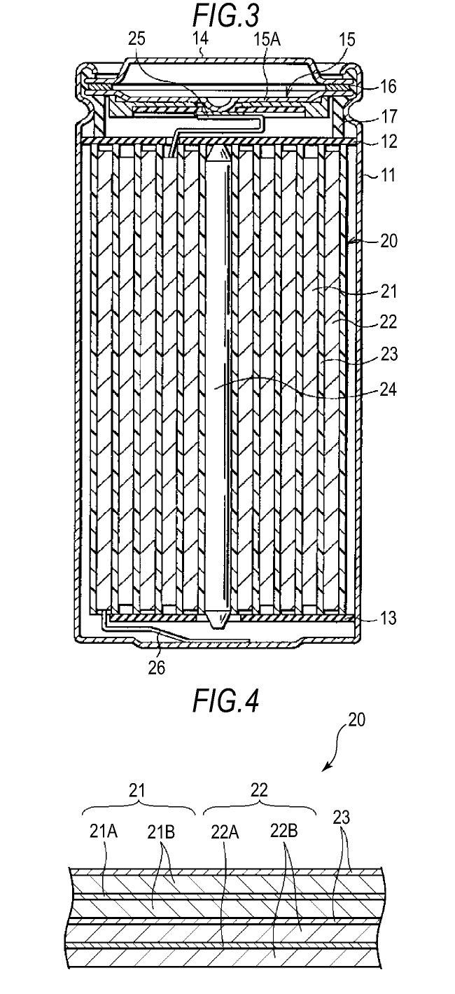

A nonaqueous electrolyte battery according to a third embodiment is described by reference to FIGS. 3 and 4. FIG. 3 shows a sectional configuration of the nonaqueous electrolyte battery according to the third embodiment. FIG. 4 enlargedly shows a part of a wound electrode body 20 shown in FIG. 3.

This nonaqueous electrolyte battery is one in which a wound electrode body 20 in which a positive electrode 21 and a negative electrode 22 are laminated via a separator 23 and wound and a pair of insulating plates 12 and 13 are mainly housed in the inside of a battery can 11 in a substantially hollow column shape. The battery structure using this columnar battery can 11 is called a cylindrical type.

This nonaqueous electrolyte battery is one in which a wound electrode body 20 in which a positive electrode 21 and a negative electrode 22 are wound via a separator 23 and a pair of insulating plates 12 and 13 are housed in the inside of a battery can 11 in a substantially hollow column shape. The battery can 11 is, for example, constituted of nickel (Ni)-plated iron (Fe), and its one end and other end are closed and opened, respectively. A pair of the insulating plates 12 and 13 is respectively disposed such that they interpose the wound electrode body 20 therebetween and extend perpendicular to the winding peripheral face thereof.

In the open end of the battery can 11, a battery lid 14 is installed by caulking with a safety valve mechanism 15 and a positive temperature coefficient device (PTC device) 16 provided in the inside of this battery lid 14 via a gasket 17, and the inside of the battery can 11 is hermetically sealed. The battery lid 14 is constituted of, for example, the same material as that in the battery can 11. The safety valve mechanism 15 is electrically connected to the battery lid 14 via the positive temperature coefficient device 16.

In this safety valve mechanism 15, when an inner pressure reaches a fixed value or more due to an internal short circuit or heating from the outside or the like, a disc plate 15A is reversed, whereby electrical connection between the battery lid 14 and the wound electrode body 20 is disconnected. The positive temperature coefficient device 16 controls the current due to an increase of the resistance in response to an increase of the temperature, thereby preventing abnormal heat generation to be caused due to a large current. The gasket 17 is constituted of, for example, an insulating material, and asphalt is coated on the surface thereof.

A center pin 24 is, for example, inserted on the center of the wound electrode body 20. In this wound electrode body 20, a positive electrode lead 25 constituted of, for example, aluminum (Al), etc. is connected to the positive electrode 21; and a negative electrode lead 26 constituted of, for example, nickel, etc. is connected to the negative electrode 22. The positive electrode lead 25 is electrically connected to the battery lid 14 by means of welding with the safety valve mechanism 15; and the negative electrode lead 26 is electrically connected to the battery can 11 by means of welding.

FIG. 4 enlargedly shows a part of the wound electrode body 20 shown in FIG. 3. The wound electrode body 20 is one in which the positive electrode 21 and the negative electrode 22 are laminated via the separator 23 and wound. An electrolytic solution is impregnated in the separator 23. For example, the positive electrode 21 is one in which a positive electrode active material layer 21B is provided on the both surfaces of a positive electrode collector 21A having a pair of surfaces opposing to each other. For example, the negative electrode 22 is one in which a negative electrode active material layer 22B is provided on the both surfaces of a negative electrode collector 22A having a pair of surfaces opposing to each other. The positive electrode collector 21A and the positive electrode active material layer 21B are the same as the positive electrode collector 33A and the positive electrode active material layer 33B, respectively according to the first embodiment. The negative electrode collector 22A and the negative electrode active material layer 22B are the same as the negative electrode collector 34A and the negative electrode active material layer 34B, respectively according to the first embodiment. Also, the separator 23 and the electrolytic solution impregnated in the separator 23 are the same as those according to the first embodiment.

(Manufacturing Method of Battery)

A manufacturing method of the foregoing nonaqueous electrolyte battery is described.

(Manufacture of Positive Electrode)

First of all, the positive electrode 21 is fabricated. First of all, a positive electrode material, a binder and a conductive agent are mixed to form a positive electrode mixture, which is then dispersed in an organic solvent to form a positive electrode mixture slurry in a paste form. Subsequently, the positive electrode mixture slurry is uniformly coated on the both surfaces of the positive electrode collector 21A by a doctor blade or a bar coater or the like and then dried. Finally, the coating film is subjected to compression molding by a roll press or the like while heating, if desired, thereby forming the positive electrode active material layer 21B. In that case, the compression molding may be repeatedly carried out plural times.

(Manufacture of Negative Electrode)

Next, the negative electrode 22 is fabricated. First of all, a negative electrode material and a binder and optionally, a conductive agent are mixed to form a negative electrode mixture, which is then dispersed in an organic solvent to form a negative electrode mixture slurry in a paste form. Subsequently, the negative electrode mixture slurry is uniformly coated on the both surfaces of the negative electrode collector 22A by a doctor blade or a bar coater or the like and then dried. Finally, the coating film is subjected to compression molding by a roll press or the like while heating, if desired, thereby forming the negative electrode active material layer 22B.

(Assembling of Battery)

Assembly of the nonaqueous electrolyte battery is carried out in the following manner. First of all, the positive electrode lead 25 is installed in the positive electrode collector 21A by means of welding, etc., and the negative electrode lead 26 is also installed in the negative electrode collector 22A by means of welding, etc. Subsequently, the positive electrode 21 and the negative electrode 22 are laminated via the separator 23 and wound to fabricate the wound electrode body 20, and the center pin 24 is then inserted on the winding center thereof. Subsequently, the wound electrode body 20 is housed in the inside of the battery can 11 while being interposed between a pair of the insulating plates 12 and 13; and a tip end of the positive electrode lead 25 is welded with the safety valve mechanism 15, whereas a tip end of the negative electrode lead 26 is welded with the battery can 11.

Subsequently, an electrolytic solution is injected into the inside of the battery can 11 and impregnated in the separator 23. Finally, the battery lid 14, the safety valve mechanism 15 and the positive temperature coefficient device 16 are fixed to the open end of the battery can 11 upon being caulked via the gasket 17. There is thus completed the nonaqueous electrolyte battery shown in FIGS. 3 and 4.

<Effect>

The third embodiment has the same effect as that in the first embodiment.

### EXAMPLES

The embodiments are not limited to the Examples below.

### Example 1-1

First of all, 94 parts by mass of a lithium cobalt complex oxide (LiCoO₂) as a positive electrode active material, 3 parts by mass of graphite as a conductive agent and 3 parts by mass of polyvinylidene fluoride (PVdF) as a binder were homogeneously mixed, to which was then added N-methylpyrrolidone, thereby obtaining a positive electrode mixture coating solution.

Subsequently, the obtained positive electrode mixture coating solution was uniformly coated on the both surfaces of a 20 μm-thick aluminum foil and then dried to form a positive electrode mixture layer of 40 mg/cm² per one surface. This was cut into a shape having a width of 30 mm and a length of 250 nm, thereby fabricating a positive electrode.

Subsequently, 97 parts by mass of graphite as a negative electrode active material and 3 parts by mass of PVdF as a binder were homogeneously mixed, to which was then added N-methylpyrrolidone, thereby obtaining a negative electrode mixture coating solution. Subsequently, the obtained negative electrode mixture coating solution was uniformly coated on the both surfaces of a 15 μm-thick copper foil serving as a negative electrode collector and then dried to form a negative electrode mixture layer of 20 mg/cm² per one surface.

This was cut into a shape having a width of 30 mm and a length of 250 mm, thereby fabricating a negative electrode. An electrolytic solution was prepared by mixing ethylene carbonate, ethyl methyl carbonate, diethyl carbonate, lithium hexafluorophosphate and isophthalonitrile in a proportion (mass ratio) of 34/17/34/14.9/0.1.

These positive electrode and negative electrode were laminated via a separator made of a 12 μm-thick microporous polyethylene film and wound, and the laminate was put in a bag made of an aluminum laminated film. 2 g of the electrolytic solution was injected into this bag, and the bag was then heat fused to fabricate a laminate type battery. A capacity of this battery was 800 mAh.

### Examples 1-2 to 1-5

The concentration of isophthalonitrile was increased or decreased as shown in Table 1, and the content of diethyl carbonate was increased or decreased for that. Laminate type batteries of Examples 1-2 to 1-5 were fabricated in the same manner as in Example 1-1, except for the foregoing point.

### Example 1-6

Terephthalonitrile was mixed in place of the isophthalonitrile, thereby preparing an electrolytic solution. A laminate type battery of Example 1-6 was fabricated in the same manner as in Example 1-1, except for the foregoing point.

### Example 1-7

1,2,4,5-Tetracyanobenzene was mixed in place of the isophthalonitrile, thereby preparing an electrolytic solution. A laminate type battery of Example 1-7 was fabricated in the same manner as in Example 1-1, except for the foregoing point.

### Example 1-8

2-Cyanopyridine was mixed in place of the isophthalonitrile, thereby preparing an electrolytic solution. A laminate type battery of Example 1-8 was fabricated in the same manner as in Example 1-1, except for the foregoing point.

### Example 1-9

3-Cyanopyridine was mixed in place of the isophthalonitrile, thereby preparing an electrolytic solution. A laminate type battery of Example 1-9 was fabricated in the same manner as in Example 1-1, except for the foregoing point.

### Example 1-10

4-Cyanopyridine was mixed in place of the isophthalonitrile, thereby preparing an electrolytic solution. A laminate type battery of Example 1-10 was fabricated in the same manner as in Example 1-1, except for the foregoing point.

### Example 1-11

2-Cyanopyrazine was mixed in place of the isophthalonitrile, thereby preparing an electrolytic solution. A laminate type battery of Example 1-11 was fabricated in the same manner as in Example 1-1, except for the foregoing point.

### Example 1-12

2,3-Dicyanopyrazine was mixed in place of the isophthalonitrile, thereby preparing an electrolytic solution. A laminate type battery of Example 1-12 was fabricated in the same manner as in Example 1-1, except for the foregoing point.

### Example 1-13

2-Cyanopyrimidine was mixed in place of the isophthalonitrile, thereby preparing an electrolytic solution. A laminate type battery of Example 1-13 was fabricated in the same manner as in Example 1-1, except for the foregoing point.

### Example 1-14

1% by mass of fluoroethylene carbonate (FEC) was added, and the content of ethylene carbonate was decreased for that, thereby preparing an electrolytic solution. A laminate type battery of Example 1-14 was fabricated in the same manner as in Example 1-1, except for the foregoing point.

### Example 1-15

1% by mass of vinylene carbonate (VC) was added, and the content of ethylene carbonate was decreased for that, thereby preparing an electrolytic solution. A laminate type battery of Example 1-15 was fabricated in the same manner as in Example 1-1, except for the foregoing point.

### Comparative Example 1-1

Isophthalonitrile was not mixed, and the content of diethyl carbonate was increased for that, thereby preparing an electrolytic solution. A laminate type battery of Comparative Example 1-1 was fabricated in the same manner as in Example 1-1, except for the foregoing point.

### Comparative Example 1-2

Benzonitrile was mixed in place of the isophthalonitrile, thereby preparing an electrolytic solution. A laminate type battery of Comparative Example 1-2 was fabricated in the same manner as in Example 1-1, except for the foregoing point.

### Comparative Example 1-3

Succinonitrile was mixed in place of the isophthalonitrile, thereby preparing an electrolytic solution. A laminate type battery of Comparative Example 1-3 was fabricated in the same manner as in Example 1-1, except for the foregoing point.

(Initial Charge and Discharge Efficiency)

With respect to the laminate type batteries of Examples 1-1 to 1-15 and Comparative Examples 1-1 to 1-3, the initial charge and discharge efficiency was measured in the following manner. Each of the laminate type batteries was charged at 4.2 V as an upper limit for 3 hours under circumstances of 23° C. and then discharged by 800 mA at 3 V as a lower limit under circumstances of 23° C. At that time, a ratio of discharge capacity to charge capacity ((discharge capacity)/(charge capacity)) was determined as the initial charge and discharge efficiency.

The measurement results are shown in Table 1.

TABLE 1

| | | Concen- | FEC | VC | Initial charge |
|---|---|---|---|---|---|
| | | tration | Concen- | Concen- | and discharge |
| | | [% by | tration | tration | efficiency |
| | Additive | mass] | [% by mass] | [% by mass] | [%] |
| Example 1-1 | Isophthalonitrile | 0.1 | — | — | 92.8 |
| Example 1-2 | Isophthalonitrile | 0.3 | — | — | 92.5 |
| Example 1-3 | Isophthalonitrile | 0.5 | — | — | 91.6 |
| Example 1-4 | Isophthalonitrile | 0.05 | — | — | 92.2 |
| Example 1-5 | Phthalonitrile | 0.1 | — | — | 92.3 |
| Example 1-6 | Terephthalonitrile | 0.1 | — | — | 92.8 |
| Example 1-7 | 1,2,4,5-Tetracyanobenzene | 0.1 | — | — | 92.9 |
| Example 1-8 | 2-Cyanopyridine | 0.1 | — | — | 92.8 |
| Example 1-9 | 3-Cyanopyridine | 0.1 | — | — | 92.5 |
| Example 1-10 | 4-Cyanopyridine | 0.1 | — | — | 92.7 |
| Example 1-11 | 2-Cyanopyrazine | 0.1 | — | — | 92.2 |
| Example 1-12 | 2,3-Dicyanopyrazine | 0.1 | — | — | 92.4 |
| Example 1-13 | 2-Cyanopyrimidine | 0.1 | — | — | 92.3 |
| Example 1-14 | Isophthalonitrile | 0.1 | 1 | — | 93.3 |
| Example 1-15 | Isophthalonitrile | 0.1 | — | 1 | 93.2 |
| Comparative | — | 0 | — | — | 91.5 |
| Example 1-1 | | | | | |
| Comparative | Benzonitrile | 0.1 | — | — | 91.5 |
| Example 1-2 | | | | | |
| Comparative | Succinonitrile | 0.1 | — | — | 91.5 |
| Example 1-3 | | | | | |

(Evaluation)

As shown in Table 1, in Examples 1-1 to 1-15, the initial charge and discharge efficiency could be improved as compared with Comparative Example 1-1. That is, in Examples 1-1 to 1-15 in which an aromatic nitrile compound having two or more nitrogen atoms was added, the initial charge and discharge efficiency could be improved as compared with Comparative Example 1-1 in which the aromatic nitrile compound having two or more nitrogen atoms was not added. According to this, it was understood that in the laminate type battery using an electrolytic solution in which an aromatic nitrile compound having two or more nitrogen atoms is added, the initial charge and discharge efficiency can be improved.

Also, in Examples 1-1 to 1-15, the initial charge and discharge efficiency could be improved as compared with Comparative Example 1-2. Also, in Comparative Example 1-2, the initial charge and discharge efficiency was the same degree as that in Comparative Example 1-1. That is, it was understood that in the aromatic nitrile compound having one nitrogen atom, such as benzonitrile, even when added to an electrolytic solution, the initial charge and discharge efficiency could not be improved unlikely the case of adding the aromatic nitrile compound having two or more nitrogen atoms.

Also, in Examples 1-1 to 1-15, the initial charge and discharge efficiency could be improved as compared with Comparative Example 1-3. Also, in Comparative Example 1-3, the initial charge and discharge efficiency was the same degree as that in Comparative Example 1-1. That is, it was understood that in the aliphatic nitrile compound having two nitrogen atoms, such as succinonitrile, even when added to an electrolytic solution, the initial charge and discharge efficiency could not be improved unlikely the case of adding the aromatic nitrile compound having two or more nitrogen atoms.

Also, according to the comparison among Examples 1-1 to 1-4, when the concentration of isophthalonitrile was 0.1% by mass or more and not more than 0.3% by mass, a larger effect was obtained. That is, it was understood that the content of the aromatic nitrile compound having two or more nitrogen atoms in the electrolytic solution is preferably 0.1% by mass or more and not more than 0.3% by mass.

Also, according to the comparison among Examples 1-1, 1-5 and 1-6, in Examples 1-1 and 1-6, the initial charge and discharge efficiency could be improved as compared with Example 1-5. According to this, it was understood that the aromatic nitrile compound in which two nitrile groups are substituted relative to the p-position or m-position of benzene is larger in the effect for enhancing the initial charge and discharge efficiency than the aromatic nitrile compound in which two nitrile groups are substituted relative to the o-position of benzene.

### Example 2-1

A separator having a thickness of 8 μm, in which polyvinylidene fluoride was coated in a thickness of 2 μm on the both surfaces thereof, was used. A laminate type battery of Example 2-1 was fabricated in the same manner as in Example 1-1, except for the foregoing point.

### Examples 2-2 to 2-5

The concentration of isophthalonitrile was increased or decreased as shown in Table 2, and the content of diethyl carbonate was increased or decreased for that. Laminate type batteries of Examples 2-2 to 2-5 were fabricated in the same manner as in Example 2-1, except for the foregoing point.

### Example 2-6

Terephthalonitrile was mixed in place of the isophthalonitrile, thereby preparing an electrolytic solution. A laminate type battery of Example 2-6 was fabricated in the same manner as in Example 2-1, except for the foregoing point.

### Example 2-7

1,2,4,5-Tetracyanobenzene was mixed in place of the isophthalonitrile, thereby preparing an electrolytic solution. A laminate type battery of Example 2-7 was fabricated in the same manner as in Example 2-1, except for the foregoing point.

### Example 2-8

2-Cyanopyridine was mixed in place of the isophthalonitrile, thereby preparing an electrolytic solution. A laminate type battery of Example 2-8 was fabricated in the same manner as in Example 2-1, except for the foregoing point.

### Example 2-9

3-Cyanopyridine was mixed in place of the isophthalonitrile, thereby preparing an electrolytic solution. A laminate type battery of Example 2-9 was fabricated in the same manner as in Example 2-1, except for the foregoing point.

### Example 2-10

4-Cyanopyridine was mixed in place of the isophthalonitrile, thereby preparing an electrolytic solution. A laminate type battery of Example 2-10 was fabricated in the same manner as in Example 2-1, except for the foregoing point.

### Example 2-11

2-Cyanopyrazine was mixed in place of the isophthalonitrile, thereby preparing an electrolytic solution. A laminate type battery of Example 2-11 was fabricated in the same manner as in Example 2-1, except for the foregoing point.

### Example 2-12

2,3-Dicyanopyrazine was mixed in place of the isophthalonitrile, thereby preparing an electrolytic solution. A laminate type battery of Example 2-12 was fabricated in the same manner as in Example 2-1, except for the foregoing point.

### Example 2-13

2-Cyanopyrimidine was mixed in place of the isophthalonitrile, thereby preparing an electrolytic solution. A laminate type battery of Example 2-13 was fabricated in the same manner as in Example 2-1, except for the foregoing point.

### Example 2-14

1% by mass of fluoroethylene carbonate was added, and the content of ethylene carbonate was decreased for that, thereby preparing an electrolytic solution. A laminate type battery of Example 2-14 was fabricated in the same manner as in Example 2-1, except for the foregoing point.

### Example 2-15

1% by mass of vinylene carbonate was added, and the content of ethylene carbonate was decreased for that, thereby preparing an electrolytic solution. A laminate type battery of Example 2-15 was fabricated in the same manner as in Example 2-1, except for the foregoing point.

### Comparative Example 2-1

Isophthalonitrile was not mixed, and the content of diethyl carbonate was increased for that, thereby preparing an electrolytic solution. A laminate type battery of Comparative Example 2-1 was fabricated in the same manner as in Example 2-1, except for the foregoing point.

### Comparative Example 2-2

Benzonitrile was mixed in place of the isophthalonitrile, thereby preparing an electrolytic solution. A laminate type battery of Comparative Example 2-2 was fabricated in the same manner as in Example 2-1, except for the foregoing point.

### Comparative Example 2-3

Succinonitrile was mixed in place of the isophthalonitrile, thereby preparing an electrolytic solution. A laminate type battery of Comparative Example 2-3 was fabricated in the same manner as in Example 2-1, except for the foregoing point.

(Initial Charge and Discharge Efficiency)

With respect to the laminate type batteries of Examples 2-1 to 2-15 and Comparative Examples 2-1 to 2-3, the initial charge and discharge efficiency was measured in the same manner as in Example 1-1.

The measurement results are shown in Table 2.

TABLE 2

| | | Concen- | FEC | VC | Initial charge |
|---|---|---|---|---|---|
| | | tration | Concen- | Concen- | and discharge |
| | | [% by | tration | tration | efficiency |
| | Additive | mass] | [% by mass] | [% by mass] | [%] |
| Example 2-1 | Isophthalonitrile | 0.1 | — | — | 92.7 |
| Example 2-2 | Isophthalonitrile | 0.3 | — | — | 92.4 |
| Example 2-3 | Isophthalonitrile | 0.5 | — | — | 91.5 |
| Example 2-4 | Isophthalonitrile | 0.05 | — | — | 92.1 |
| Example 2-5 | Phthalonitrile | 0.1 | — | — | 92.2 |
| Example 2-6 | Terephthalonitrile | 0.1 | — | — | 92.7 |
| Example 2-7 | 1,2,4,5-Tetracyanobenzene | 0.1 | — | — | 92.8 |
| Example 2-8 | 2-Cyanopyridine | 0.1 | — | — | 92.7 |
| Example 2-9 | 3-Cyanopyridine | 0.1 | — | — | 92.4 |
| Example 2-10 | 4-Cyanopyridine | 0.1 | — | — | 92.6 |
| Example 2-11 | 2-Cyanopyrazine | 0.1 | — | — | 92.1 |
| Example 2-12 | 2,3-Dicyanopyrazine | 0.1 | — | — | 92.3 |
| Example 2-13 | 2-Cyanopyrimidine | 0.1 | — | — | 92.2 |
| Example 2-14 | Isophthalonitrile | 0.1 | 1 | — | 93.2 |
| Example 2-15 | Isophthalonitrile | 0.1 | — | 1 | 93.1 |
| Comparative | — | 0 | — | — | 91.4 |
| Example 2-1 | | | | | |
| Comparative | Benzonitrile | 0.1 | — | — | 91.4 |
| Example 2-2 | | | | | |
| Comparative | Succinonitrile | 0.1 | — | — | 91.4 |
| Example 2-3 | | | | | |

(Evaluation)

As shown in Table 2, in Examples 2-1 to 2-15, the initial charge and discharge efficiency could be improved as compared with Comparative Example 2-1. That is, in Examples 2-1 to 2-15 in which an aromatic nitrile compound having two or more nitrogen atoms was added, the initial charge and discharge efficiency could be improved as compared with Comparative Example 2-1 in which the aromatic nitrile compound having two or more nitrogen atoms was not added. According to this, it was understood that in the laminate type battery using an electrolyte in a gel form containing an electrolytic solution in which an aromatic nitrile compound having two or more nitrogen atoms is added, the initial charge and discharge efficiency can be improved.

Also, in Examples 2-1 to 2-15, the initial charge and discharge efficiency could be improved as compared with Comparative Example 2-2. Also, in Comparative Example 2-2, the initial charge and discharge efficiency was the same degree as that in Comparative Example 2-1. That is, it was understood that in the aromatic nitrile compound having one nitrogen atom, such as benzonitrile, even when added to an electrolytic solution, the initial charge and discharge efficiency could not be improved unlikely the case of adding the aromatic nitrile compound having two or more nitrogen atoms.

Also, in Examples 2-1 to 2-15, the initial charge and discharge efficiency could be improved as compared with Comparative Example 2-3. Also, in Comparative Example 2-3, the initial charge and discharge efficiency was the same degree as that in Comparative Example 2-1. That is, it was understood that in the aliphatic nitrile compound having two nitrogen atoms, such as succinonitrile, even when added to an electrolytic solution, the initial charge and discharge efficiency could not be improved unlikely the case of adding the aromatic nitrile compound having two or more nitrogen atoms.

Also, according to the comparison among Examples 2-1, 2-5 and 2-6, in Examples 2-1 and 2-6, the initial charge and discharge efficiency could be improved as compared with Example 2-5. According to this, it was understood that the aromatic nitrile compound in which two nitrile groups are substituted relative to the p-position or m-position of benzene is larger in the effect as the additive than the aromatic nitrile compound in which two nitrile groups are substituted relative to the o-position of benzene.

### Example 3-1

A lithium nickel cobalt aluminum complex oxide (LiNi_{0.77}Co_{0.20}Al_{0.03}O₂) was used as the positive electrode active material in place of the lithium cobalt complex oxide (LiCoO₂). A laminate type battery of Example 3-1 was fabricated in the same manner as in Example 1-1, except for the foregoing point.

### Comparative Example 3-1

Isophthalonitrile was not mixed, and the content of diethyl carbonate was increased for that, thereby preparing an electrolytic solution. A laminate type battery of Comparative Example 3-1 was fabricated in the same manner as in Example 3-1, except for the foregoing point.

(Initial Charge and Discharge Efficiency)

With respect to the laminate type batteries of Example 3-1 and Comparative Example 3-1, the initial charge and discharge efficiency was measured in the same manner as in Example 1-1.

The measurement results are shown in Table 3.

TABLE 3

| | | | FEC | VC | Initial charge |
|---|---|---|---|---|---|
| | | | Concen- | Concen- | and discharge |
| | | Concentration | tration | tration | efficiency |
| | Additive | [% by mass] | [% by mass] | [% by mass] | [%] |
| Example 3-1 | Isophthalonitrile | 0.1 | — | — | 90.1 |
| Comparative | — | 0 | — | — | 88.8 |
| Example 3-1 | | | | | |

[Evaluation]

As shown in Table 3, in Example 3-1, the initial charge and discharge efficiency could be improved as compared with Comparative Example 3-1. That is, in Example 3-1 in which an aromatic nitrile compound having two or more nitrogen atoms was added, the initial charge and discharge efficiency could be improved as compared with Comparative Example 3-1 in which the aromatic nitrile compound having two or more nitrogen atoms was not added. According to this, it was understood that even in the case of using LiNi_{0.77}Co_{0.20}Al_{0.03}O₂ as the positive electrode active material, in the laminate type battery using an electrolytic solution in which an aromatic nitrile compound having two or more nitrogen atoms is added, the initial charge and discharge efficiency can be improved.

### 4. Other Embodiments

While in the foregoing embodiments and working examples, the batteries having a battery structure of a laminated film type or cylindrical type and the batteries having a wound structure having electrodes wound therein have been described, the embodiments are also applicable to batteries having other battery structure, for example, a rectangular type, a coin type, a button type, etc. and batteries having a laminated structure in which electrodes are laminated, and the same effects can be obtained.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A nonaqueous electrolyte battery comprising:
a positive electrode;
a negative electrode; and
a nonaqueous electrolyte,
wherein the nonaqueous electrolyte contains
a solvent,
an electrolyte salt and
an additive, and
wherein the additive includes an aromatic nitrile compound having two or more nitrogen atoms.

2. The nonaqueous electrolyte battery according to claim 1,
wherein the aromatic nitrile compound having two or more nitrogen atoms is an aromatic nitrile compound represented by the following formula (1): 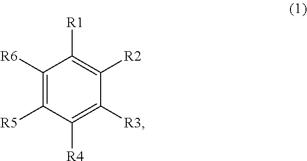
wherein
each of R1 to R6 independently represents a CₘH₂ₘ₊₁ group (0≦m≦4), an F group, a Cl group, a Br group or a CN group, and at least two of R1 to R6 are a CN group.

3. The nonaqueous electrolyte battery according to claim 1,
wherein the aromatic nitrile compound having two or more nitrogen atoms is an aromatic nitrile compound represented by any one of the following formulae (2) and (3): 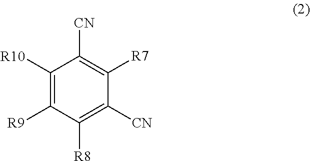
wherein each of R7 to R10 independently represents a CₘH₂ₘ₊₁ group (0≦m≦4), an F group, a Cl group, a Br group or a CN group; and 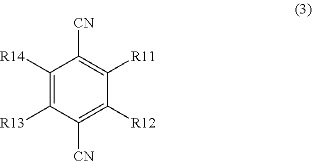
wherein each of R11 to R14 independently represents a CₘH₂ₘ₊₁ group (0≦m≦4), an F group, a Cl group, a Br group or a CN group.

4. The nonaqueous electrolyte battery according to claim 1,
wherein the aromatic nitrile compound having two or more nitrogen atoms is an aromatic nitrile compound represented by any one of the following formulae (4) to (6): 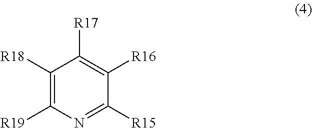
wherein each of R15 to R19 independently represents a CₘH₂ₘ₊₁ group (0≦m≦4), an F group, a Cl group, a Br group or a CN group; and at least one of R15 to R19 is a CN group; 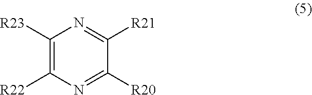
wherein each of R20 to R23 independently represents a CₘH₂ₘ₊₁ group (0≦m≦4), an F group, a Cl group, a Br group or a CN group; and at least one of R20 to R23 is a CN group; and 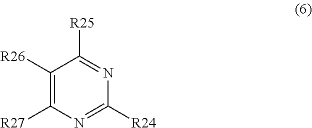
wherein each of R24 to R27 independently represents a CₘH₂ₘ₊₁ group (0≦m≦4), an F group, a Cl group, a Br group or a CN group; and at least one of R24 to R27 is a CN group.

5. The nonaqueous electrolyte battery according to claim 1,
wherein a content of the additive is 0.1% by mass or more and not more than 0.3% by mass relative to the whole mass of the nonaqueous electrolyte.

6. The nonaqueous electrolyte battery according to claim 1, wherein the nonaqueous electrolyte includes a halogenated carbonate.

7. The nonaqueous electrolyte battery according to claim 1, wherein the nonaqueous electrolyte includes a carbonate having a carbon-carbon multiple bond.

8. The nonaqueous electrolyte battery according to claim 1, wherein the nonaqueous electrolyte is an electrolyte in a gel form containing:
an electrolytic solution containing the solvent, the electrolyte salt and the additive; and
a polymer compound having swollen upon absorbing the electrolytic solution.

9. The nonaqueous electrolyte battery according to claim 8, wherein
the polymer compound includes polyvinylidene fluoride.

10. The nonaqueous electrolyte battery according to claim 1 comprising a laminated film outer package.

11. A nonaqueous electrolyte comprising:
a solvent;
an electrolyte salt; and
an additive,
wherein the additive includes an aromatic nitrile compound having two or more nitrogen atoms.
